(19) United States
(12) Patent Application Publication
(10) Pub. No.: US 2014/0067622 A1
(43) Pub. Date: Mar. 6, 2014

(54) SYSTEMS AND METHODS FOR WEB BASED COMMERCE

(71) Applicant: Philippe Benoliel, Los Angeles, CA (US)

(72) Inventor: Philippe Benoliel, Los Angeles, CA (US)

(21) Appl. No.: 13/604,483

(22) Filed: Sep. 5, 2012

(51) Int. Cl. G06Q 30/00

(52) U.S. Cl. 705/27.1

(57) ABSTRACT

Systems and methods described herein related to e-commerce, including web based commerce sites. In an embodiment, a template can be embedded into an existing e-commerce site by creating the template and adding the template to an e-commerce site using a card adapter. Information can be presented to a user based on the template and data that may be received from the user related to an order placed using the e-commerce site and embedded template. The order can be passed to a fulfillment site.

### FIELD OF THE INVENTION

Embodiments of the invention relate to systems and methods for use in the embedded applications. More particularly, some embodiments relate to web commerce.

### BACKGROUND OF THE INVENTION

Web based or electronic commerce, also known as “e-commerce,” refers to the buying and selling of products or services over electronic systems such as the Internet or other computer networks. The term may also refer to the process of online developing, marketing, selling, delivering, servicing and paying for products and services. The amount of trade conducted electronically has grown and continues to grow with widespread Internet usage. The use of commerce is conducted in this way, spurring and drawing on innovations in electronic funds transfer, supply chain management, Internet marketing, online transaction processing, electronic data interchange (EDI), inventory management systems, and automated data collection systems. Modern electronic commerce typically uses the World Wide Web at least at one point in the transaction's life-cycle, although it may encompass a wider range of technologies such as e-mail, mobile devices and telephones as well.

A large percentage of electronic commerce is conducted entirely in electronic form for virtual items such as access to premium content on a website, but electronic commerce can involve the transportation of physical items in some way. Electronic commerce is generally considered to be the sales aspect of e-business. It also consists of the exchange of data to facilitate the financing and payment aspects of business transactions.

### SUMMARY OF THE INVENTION

Various embodiments of the systems and methods described herein are related to a web application. Some embodiments include a processor and a memory coupled to the processor storing instructions. These instructions can cause the processor to implement methods in accordance with the systems and methods described herein. In an example embodiment, a web based system can produce customization on an e-commerce site for brand owners, manufacturers, consumers, etc.

To this end, in an exemplary embodiment of the present invention, a method comprising: creating a template; adding the template to an e-commerce site; presenting information to a user based on the template; receiving data related to an order from the user; and passing the order data to a fulfillment site.

In an exemplary embodiment, comprising using a template builder to create the template, wherein the template builder includes a web based system that allows a manufacturer to create a template for sales of a product on a web site controlled by a retailer.

In an exemplary embodiment, further comprising using a card adapter to embed a template into a web site, the web site providing a front end viewable by a purchaser.

In an exemplary embodiment, further comprising using a fulfillment adapter to fill orders, the fulfillment adapter passing orders through to a source for the order.

In an exemplary embodiment, further comprising receiving data related to a customized order and customizing the order based on the received data related to the customization.

In an exemplary embodiment, wherein the template defines where an ordered item can be produced based on a predefined characteristic.

In an exemplary embodiment, wherein the template defines how an ordered item can be produced based on a predefined characteristic.

In another exemplary embodiment, a computer program product comprising: a non-transitory computer readable medium including instructions causing a computer to perform the following steps: creating a template; adding the template to an e-commerce site; presenting information to a user based on the template; receiving data related to an order from the user; and passing the order data to a fulfillment site.

In an exemplary embodiment, further comprising instructions implementing a template builder to create the template, wherein the template builder includes a web based system that allows a manufacturer to create a template for sales of a product on a web site controlled by a retailer.

In an exemplary embodiment, further comprising instructions implementing a card adapter to embed a template into a web site, the web site providing a front end viewable by a purchaser.

In an exemplary embodiment, further comprising instructions implementing a fulfillment adapter to fill orders, the fulfillment adapter passing orders through to a source for the order.

In an exemplary embodiment, further comprising instructions for receiving data related to a customized order and customizing the order based on the received data related to the customization.

In an exemplary embodiment, further comprising instructions for creating the template such that it defines where an ordered item can be produced based on a predefined characteristic.

In an exemplary embodiment, further comprising instructions for creating the template such that it defines how an ordered item can be produced based on a predefined characteristic.

In another exemplary embodiment, a system comprising: a processor; a memory, coupled to the processor, the memory including instructions causing the processor to: create a template; add the template to an e-commerce site; present information to a user based on the template; receive data related to an order from the user; and pass the order data to a fulfillment site.

In an exemplary embodiment, wherein the processor further executes instructions causing the system to create the template within a template builder, wherein the template builder includes a web based system that allows a manufacturer to create a template for sales of a product on a web site controlled by a retailer.

In an exemplary embodiment, wherein the processor further executes instructions causing the system to embed a template into a web site using a card adapter, the web site providing a front end viewable by a purchaser.

In an exemplary embodiment, wherein the processor further executes instructions causing the system to fill orders using a fulfillment adapter, the fulfillment adapter passing orders through to a source for the order.

In an exemplary embodiment, wherein the processor further executes instructions causing the system to receive data related to a customized order and customizing the order based on the received data related to the customization.

In an exemplary embodiment, wherein the processor further executes instructions causing the system to use a template to define where something can be produced based on a predefined characteristic.

An exemplary embodiment provides a front end e-commerce system that may be embedded into existing e-commerce systems. It will be understood that such a system may be a front end for many or all currently existing e-commerce systems, as well as many, and perhaps all, e-commerce systems that may be developed in the future.

An exemplary embodiment provides a generic system that may interact with many and perhaps any, e-commerce systems. It will be understood that such a system may interact with many or all currently existing e-commerce systems, as well as many, and perhaps all, e-commerce systems that may be developed in the future.

An exemplary embodiment provides for back end configuration of e-commerce systems. It will be understood that such a system may be used with many or all currently existing e-commerce systems, as well as many, and perhaps all, e-commerce systems that may be developed in the future.

An exemplary embodiment provides for back end configuration that allows one or more e-commerce sites to decide what to use the system for to provide additional e-commerce features. It will be understood that such a system may be used with many or all currently existing e-commerce systems, as well as many, and perhaps all, e-commerce systems that may be developed in the future.

An exemplary embodiment provides for back end configuration that allows one or more e-commerce sites to decide how to use the system for to provide additional e-commerce features. It will be understood that such a system may be used with many or all currently existing e-commerce systems, as well as many, and perhaps all, e-commerce systems that may be developed in the future or other current or future web sites.

An exemplary embodiment provides for personalization tools that can be used in conjunction with an e-commerce site. It will be understood that such a system may be used with many or all currently existing e-commerce systems, as well as many, and perhaps all, e-commerce systems that may be developed in the future or other current or future web sites.

An exemplary embodiment provides for personalization tools that can be used to provide flexibility in the function and operation of an e-commerce site. It will be understood that such a system may be used with many or all currently existing e-commerce systems, as well as many, and perhaps all, e-commerce systems that may be developed in the future or other current or future web sites.

An exemplary embodiment provides for personalization tools that allow a user to log in to a system administration tool that can define what a user may do within an e-commerce system or a system embedded within an e-commerce system. It will be understood that such a system may be used with many or all currently existing e-commerce systems, as well as many, and perhaps all, e-commerce systems that may be developed in the future or other current or future web sites.

An exemplary embodiment provides for personalization tools that allow a user to log in to a system administration tool that can define what a user may do within a system embedded within an e-commerce system. It will be understood that such a system may be used with many or all currently existing e-commerce systems, as well as many, and perhaps all, e-commerce systems that may be developed in the future or other current or future web sites.

An exemplary embodiment provides for personalization tools that allow a user to select products which allow customization within an e-commerce system or a system embedded within an e-commerce system. It will be understood that such a system may be used with many or all currently existing e-commerce systems, as well as many, and perhaps all, e-commerce systems that may be developed in the future or other current or future web sites.

An exemplary embodiment provides for original equipment manufacturer (OEM) product manufacturers to create a template. It will be understood that such a system may be used with many or all currently existing e-commerce systems, as well as many, and perhaps all, e-commerce systems that may be developed in the future or other current or future web sites.

An exemplary embodiment provides for a template builder that enables manufacturers to create templates. It will be understood that such a system may be used with many or all currently existing e-commerce systems, as well as many, and perhaps all, e-commerce systems that may be developed in the future or other current or future web sites.

An exemplary embodiment provides a card adapter that can allow the systems and methods described herein to interact with a website. It will be understood that such a system may be used with many or all currently existing e-commerce systems, as well as many, and perhaps all, e-commerce systems that may be developed in the future or other current or future web sites.

An exemplary embodiment provides a card adapter that can allow the systems and methods described herein to be embedded seamlessly within a website including many or all currently existing e-commerce web sites or systems, as well as many, and perhaps all, e-commerce systems and websites that may be developed in the future or other current or future web sites.

An exemplary embodiment provides a front end as one place, or web location, to check out or make purchases. This may be applied to customized products and non-customized products. It will be understood that such a system may be used with many or all currently existing e-commerce systems, as well as many, and perhaps all, e-commerce systems that may be developed in the future or other current or future web sites.

An exemplary embodiment provides a pass through of orders that can provide for more than one order from different fulfillment systems. For example, the systems and methods described herein may provide for more than one order from different fulfillment systems to be sent from one place. In another example, the systems and methods described herein may provide for more than one order from different fulfillment systems to be sent to one place. It will be understood that such a system may be used with many or all currently existing e-commerce systems, as well as many, and perhaps all, e-commerce systems that may be developed in the future or other current or future web sites.

An exemplary embodiment provides a fulfillment adaptor that may send an order for an item to an e-commerce system to build an order. It will be understood that such a system may be used with many or all currently existing e-commerce systems, as well as many, and perhaps all, e-commerce systems that may be developed in the future or other current or future web sites.

An exemplary embodiment provides a fulfillment adaptor that may send orders for various items to an e-commerce system to build an order. For example, the systems and methods described herein may provide for a combination of orders from multiple providers that may be processed on a single web site. It will be understood that such a system may be used with many or all currently existing e-commerce systems, as well as many, and perhaps all, e-commerce systems that may be developed in the future or other current or future web sites.

An exemplary embodiment provides a template that provides a fulfillment adaptor that may send an order for an item to an e-commerce system to build an order. It will be understood that such a system may be used with many or all currently existing e-commerce systems, as well as many, and perhaps all, e-commerce systems that may be developed in the future or other current or future web sites.

An exemplary embodiment provides a template that defines where something can be produced based on predefined characteristics. It will be understood that such a system may be used with many or all currently existing e-commerce systems, as well as many, and perhaps all, e-commerce systems that may be developed in the future or other current or future web sites.

An exemplary embodiment provides a template that defines how something can be produced based on predefined characteristics. It will be understood that such a system may be used with many or all currently existing e-commerce systems, as well as many, and perhaps all, e-commerce systems that may be developed in the future or other current or future web sites.

An exemplary embodiment provides a system at least partially using a HyperText Markup Language (HTML). Such a system may be used across multiple computing systems. For example, many or all computing systems having a web browser such as on a personal computer, Macintosh® computer, mobile phone, smart phone, tablet computer, desktop computer, laptop computer, notebook, or other computing device configured for web browsing, e.g., using HTML.

An exemplary embodiment provides a system at least partially using one or more of the various versions of HTML, such as, for example, HTML5. Such a system may also be used across multiple computing systems by using a computing device configured to use, e.g., HTML5.

An exemplary embodiment integrates seamlessly into existing e-commerce systems, online stores, or both to provide extended product offerings. It will be understood that such a system may be used with many or all currently existing e-commerce systems, as well as many, and perhaps all, e-commerce systems that may be developed in the future or other current or future web sites.

An exemplary embodiment integrates seamlessly with fulfillment partners, manufacturers, and drop shippers, to transmit and update order information and statuses.

An exemplary embodiment can allow brand partners, for example, to increase the assortment of products, product types, product designs, or some combination of these, available for sale on a web site while reducing inventory risk and maintaining margins.

An exemplary embodiment can allow for pass through of items for sale on a web site owned by a brand partner to increase the assortment of products, product types, product designs, or some combination of these, available for sale on a web site while reducing inventory risk and maintaining margins, for example.

An exemplary embodiment can allow for consumers to engage with their favorite brands to customize or personalize products while enforcing rules that can be defined by an intellectual property owner.

An exemplary embodiment can allow syndication across, for example, the Internet, by placing a product, and perhaps personalization capabilities, where an audience, e.g., consumers, are located, for example, in popular stores, on social networking sites, on popular e-commerce sites, etc.

An exemplary embodiment can integrate a system into existing e-commerce systems, large operating stores, or both.

An exemplary embodiment can provide a technological solution, a fulfillment solution, or both.

An exemplary embodiment can allow for extension of product lines, personalization of products, on-demand manufacturing of products, reduced inventory, deployment of customized systems, rapid time to market, or a combination of these.

An exemplary embodiment can provide an adapter to a client's e-commerce site.

An exemplary embodiment can provide a fulfillment adapter.

An exemplary embodiment can provide for deployment with customization tools onto one or more stores, selection of new products, and design and management of rules specific to an instance of an application.

It will be understood that the system and methods described herein may be used with many or all currently existing e-commerce systems, as well as many, and perhaps all, e-commerce systems that may be developed in the future or other current or future web sites. Additionally, it will be understood that the various aspects of the exemplary embodiments, such as those discussed above, can generally be combined.

### BRIEF DESCRIPTION OF THE DRAWINGS

FIG. 1 is a diagram illustrating an example system in accordance with the systems and methods described herein.

FIG. 2 is another diagram illustrating an example system in accordance with the systems and methods described herein.

FIG. 3 is a flowchart depicting an example method in accordance with the systems and methods described herein.

### DETAILED DESCRIPTION OF THE PREFERRED EMBODIMENT

FIG. 1 is a diagram illustrating an example system 100 in accordance with the systems and methods described herein. The illustrated embodiment of FIG. 1 includes the system 100 that has an e-commerce site 102. A front end 104 to e-commerce system 102 is embedded into the e-commerce systems 102, such as currently existing e-commerce systems or e-commerce systems that may be developed in the future.

The e-commerce site 102 and front end 104 may be connected over, for example, the Internet 106 to a user 108. Thus, the user may interact with the platform 110, which includes e-commerce site 102 and front end 104, over the Internet 106.

Accordingly, the systems 100 described herein may provide a system at least partially using a HyperText Markup Language (HTML) such that such a system may be used across multiple computing devices. For example, many or all computing systems having a web browser such as on a personal computer, Macintosh® computer, mobile phone, smart phone, tablet computer, desktop computer, laptop computer, notebook, or other computing device configured for web browsing, e.g., using HTML, might be used. An exemplary embodiment provides a system at least partially using one or more of the various versions of HTML, such as, for example, HTML5. Such a system may also be used across multiple platforms by using a computing device configured to use, e.g., HTML5.

Front end 104 can provide a generic platform 110 that may allow user 108 to interact with many e-commerce systems, such as e-commerce system 102. For example, user 108 may place an order over the Internet 106 with platform 110. The front end 104 provides features, products, fulfillment options, and flexibility that the e-commerce site 102 alone cannot.

The front end 104 may include personalization tools that allow a user to log in to a system administration tool that can define what a user may do within an e-commerce system or a system embedded within an e-commerce system. An exemplary embodiment provides for personalization tools that allow a user to select products which allow customization within an e-commerce system or a system embedded within an e-commerce system.

In some embodiments, a card adapter allows the systems and methods described herein to interact with a website. For example, the card adapter may embed a template into an existing e-commerce site. The system can provide a front end system for orders. Such tools may also allow users to personalize or customize a product. An exemplary embodiment can allow for consumers to engage with their favorite brands to customize or personalize products while enforcing rules that can be defined by an intellectual property owner.

Various embodiments of the systems and methods described herein are related to a web application platform. Some embodiments include a processor and a memory coupled to the processor storing instructions. These instructions can cause the processor to implement methods in accordance with the systems and methods described herein. In an example embodiment a web based platform can product customization on an e-commerce site for brand owners, manufacturers, consumers, etc. The instructions may be stored on a computer readable medium. Some examples of computer readable medium includes magnetic media such as magnetic disks, cards, tapes, and drums, punched cards and paper tapes, optical disks, barcodes and magnetic ink characters, floppy disks, hard drives, zip drives, thumb drives, computer memory, and any other non-transitory medium.

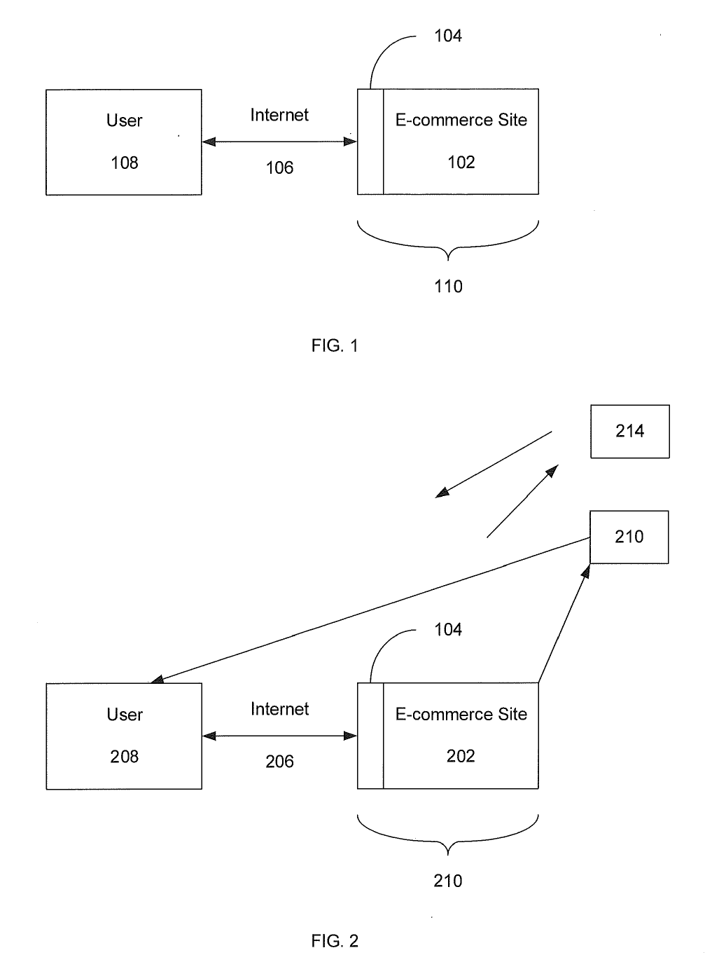

FIG. 2 is a diagram illustrating an example system 200 in accordance with the systems and methods described herein. The illustrated embodiment of FIG. 2 includes the system 200 that has an e-commerce site 202. A front end 204 to e-commerce system 202 is embedded into the e-commerce systems 202, such as currently existing e-commerce systems or e-commerce systems that may be developed in the future. The e-commerce site 202 and front end 204 may be connected over, for example, the Internet 206 to a user 208. Thus, the user may interact with the platform 216, which includes e-commerce site 202 and front end 204, over the Internet 206.

In the illustrated embodiment a product provider 210, such as a warehouse, manufacturer, or other product provider can interact with user 208 directly or through platform 216. For example, e-commerce platform 216 may provide a “web store” that user 208 can view to find products, purchase products, etc. Additionally, in the illustrated example, the product may be sent to the user 208 directly rather than first by, e.g., an e-commerce retailer that owns the e-commerce site 202. In this way shipping, storing, inventory risk, etc. might be minimized to the e-commerce provider.

Thus, the exemplary embodiment illustrated in FIG. 2 may provide a front end 204 as one place, or web location, to check out or make purchases. The front end 204 can provide a pass through 212 of orders that can provide for more than one order from different fulfillment systems 210, 214. For example, the systems and methods described herein may provide for more than one order from different fulfillment systems 210, 214 to be sent to one place, e.g., the user 208.

The system 200 illustrated in FIG. 2 can provide for syndication across, for example, the Internet 206, by placing a product, and perhaps personalization capabilities, where an audience, e.g., consumers (or users 208), are located, for example, in popular stores, on social networking sites, on popular e-commerce sites, etc. Accordingly, the users 208 may access sites that are already widely used, while the products are sold on other sites with an example system described herein provides a pass through of items for sale on one web site to a web site owned by, e.g., a brand partner. Such a brand partner can provide access to potential purchasers, while the underlying fulfillment system 210, 214 can provide for an increase in the assortment of products, product types, product designs, or some combination of these, available for sale on a web site while reducing inventory risk and maintaining margins, for example. For example, system 200 may integrate a platform into existing e-commerce platforms 202. A fulfillment adaptor may be used to send an order for an item to an e-commerce system, a system to build an order.

In an example system, fulfillment systems 210, 214 may provide customize products, non-customized products, or both. For example, a user 208 might want to include a name on a shirt. This service might be provided by the fulfillment systems 210, 214. For example, an exemplary embodiment may provide for personalization tools through e-commerce platform 216 that can be used to provide flexibility in the function and operation of an e-commerce site. In such an embodiment personalization tools can be used in conjunction with an e-commerce site 202 such that a product ordered might be customized at fulfillment systems 210, 214.

The system 200 can integrate seamlessly with fulfillment partners 210, 214, which can include manufacturers and/or drop shippers, for example, to transmit and update order information and statuses. The fulfillment partners 210, 214 can provide the contents of the order.

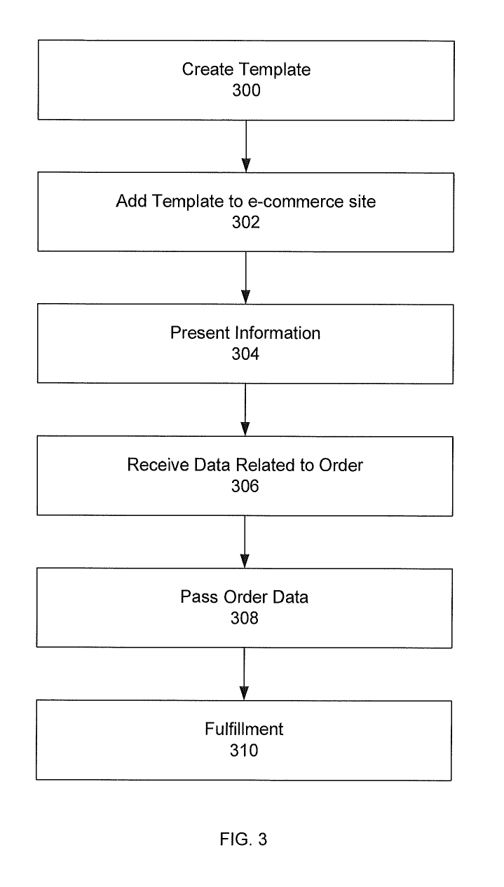

FIG. 3 is a flowchart depicting an example method in accordance with the systems and methods described herein. In step 300 of the illustrated embodiment a template is created. In an exemplary embodiment provides for original equipment manufacturer (OEM) product manufacturers to create a template. Additionally, some systems provide a template builder that enables manufacturers to create templates. The template that defines where or how something can be produced based on predefined characteristics. The template may also provide a fulfillment adaptor that may send an order for an item to an e-commerce system to build an order.

In step 302 the template may be added to an e-commerce site. In an exemplary embodiment the template can allow for a template to integrate seamlessly into existing e-commerce platforms, online stores, or both to provide extended product offerings.

In step 304 information received from a user and entered, for example, using the template can be presented to a device, such as a fulfillment adaptor. In this goods and services may be provided through another supplier, rather than directly from the e-commerce vendor. This can allow for less risk and lower inventory requirements for the e-commerce vendor.

In step 306 data related to the order can be received. For example, this data might include an item number for an item that is ordered, an item description for the item ordered, a quantity for the item ordered, and a price. It will be understood, however, that this is only an example. In other example systems different data may be provided. For example, in some embodiments, price and payment might be processed at the e-commerce front end, rather than by the fulfillment provider.

The order data can be passed through the system, in step 308, for example, to the fulfillment adapter so that the order may be filled in step 310. In some systems the fulfillment center may ship an order directly to a person who has placed an order, without the need for the e-commerce site to receive the item, store the item, pre-pay for the item, etc. For example, in some embodiments of the systems and methods described herein, an e-commerce vendor may act as a front end store front for underlying suppliers such as manufacturers or other vendors. For example, in some cases a large number of specialized vendors that might cater to a specific need might all sell through a single e-commerce site. In this way these vendors may concentrate on their specialized area without a customer needing to search for a website that only supplies a narrow product line.

Various systems and methods described herein may be implemented using a computer. The computer can be a personal computer, laptop computer, desktop computer, mainframe, minicomputer, etc. The systems and methods described herein may be implemented over a network of computers. For example, some embodiments may use the Internet. The Internet is a global system of interconnected computer networks that use the standard Internet protocol suite (TCP/IP) to serve billions of users worldwide. The systems and methods described herein are not limited to implement over the Internet, however. In some embodiments, other systems of networked computers or networked computing devices might be used to set up an e-commerce system.

Further, the systems and methods described herein may be implemented in hardware, software, or a combination of both. Such software may run on processors, such as microprocessors, that may be part of a computer system. Example processors might also include digital logic, programmable logic, analog circuitry, digital circuitry, or other circuitry used to implement a processing function. For example, a processor might be implemented on one or more filed programmable gate arrays (FPGAs) or other programmable logic. Processing functions might also be implemented using application specific integrated circuits (ASICs). It will also be understood that any combination of these might be combined to provide for such processing functions.

The communications between computing devices on a network may include wired or wireless communication, terrestrial or satellite based communication, or any other currently known or later developed communication system that might be used in conjunction with the Internet or other computer or computing system based network to provide communication connections between the computers or computing devices. Additionally, it will be understood that combinations of communication systems may be used, such as both terrestrial and satellite based communication.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

1. A method comprising:
creating a template;
adding the template to an e-commerce site;
presenting information to a user based on the template;
receiving data related to an order from the user; and
using a fulfillment adapter to pass the order data to a fulfillment site, wherein multiple different fulfillment sites may be used to fill an order; and
wherein steps of the method are implemented using hardware, software, or a combination of both, and where for steps of the method that are implemented using software, the software includes instructions stored in an executable format on one or more non-transitory machine-readable mediums.

2. The method of claim 1, further comprising using a template builder to create the template, wherein the template builder includes a web based system that allows a manufacturer to create a template for sales of a product on a web site controlled by a retailer.

3. The method of claim 1, further comprising using a card adapter to embed a template into multiple different web sites, the web sites providing front ends viewable by a purchaser.

4. The method of claim 1, further comprising using the fulfillment adapter to fill orders, the fulfillment adapter passing a first orderthrough to a first source and passing a second order through to a second source different from the first source.

5. The method of claim 1, further comprising receiving data related to a customized order and customizing the order based on the received data related to the customization.

6. The method of claim 1, wherein the template defines where an ordered item can be produced based on a predefined characteristic.

7. The method of claim 1, wherein the template defines how an ordered item can be produced based on a predefined characteristic.

8. A computer program product comprising:
a non-transitory computer readable medium including instructions causing a computer to perform the following steps:
creating a template;
adding the template to an e-commerce site;
presenting information to a user based on the template;
receiving data related to an order from the user; and
using a fulfillment adapter to pass the order data to a fulfillment site, wherein multiple different fulfillment sites may be used to fill an order.

9. The computer program product of claim 8, further comprising instructions implementing a template builder to create the template, wherein the template builder includes a web based system that allows a manufacturer to create a template for sales of a product on a web site controlled by a retailer.

10. The computer program product of claim 8, further comprising instructions implementing a card adapter to embed a template into multiple different web sites, the web sites providing front ends viewable by a purchaser.

11. The non-transitory computer readable medium of claim 8, further comprising instructions implementing the fulfillment adapter to fill orders, the fulfillment adapter passing a first orderthrough to a first source and passing a second order through to a second source different from the first source.

12. The non-transitory computer readable medium of claim 8, further comprising instructions for receiving data related to a customized order and customizing the order based on the received data related to the customization.

13. The non-transitory computer readable medium of claim 8, further comprising instructions for creating the template such that it defines where an ordered item can be produced based on a predefined characteristic.

14. The computer readable medium of claim 8, further comprising instructions for creating the template such that it defines how an ordered item can be produced based on a predefined characteristic.

15. A system comprising:
a processor;
a memory, coupled to the processor, the memory including instructions causing the processor to:
create a template;
add the template to multiple different e-commerce sites;
present information to a user based on the template;
receive data related to an order from the user; and
pass the order data to a fulfillment site.

16. The system of claim 15, wherein the processor further executes instructions causing the system to create the template within a template builder, wherein the template builder includes a web based system that allows a manufacturer to create a template for sales of a product on a web site controlled by a retailer.

17. The system of claim 15, wherein the processor further executes instructions causing the system to embed a template into the multiple different e-commerce sites using a card adapter, the multiple different e-commerce sites providing front ends viewable by a purchaser.

18. The system of claim 15, wherein the processor further executes instructions causing the system to fill orders using a fulfillment adapter, the fulfillment adapter passing a first order through to a first fulfillment site and passing a second order through to a second fulfillment site different from the first fulfillment site.

19. The system of claim 15, wherein the processor further executes instructions causing the system to receive data related to a customized order and customizing the order based on the received data related to the customization.

20. The system of claim 15, wherein the processor further executes instructions causing the system to use a template to define where something can be produced based on a predefined characteristic.
